(19) United States
(12) Patent Application Publication
(10) Pub. No.: US 2020/0012137 A1
(43) Pub. Date: Jan. 9, 2020

(54) SUBSTRATE FOR DISPLAY DEVICE, DISPLAY DEVICE, AND METHOD OF PRODUCING SUBSTRATE FOR DISPLAY DEVICE

(71) Applicant: SHARP KABUSHIKI KAISHA, Sakai City (JP)

(72) Inventor: SHINICHI HIRATO, Sakai City (JP)

(21) Appl. No.: 16/503,228

(22) Filed: Jul. 3, 2019

Related U.S. Application Data
(60) Provisional application No. 62/695,348, filed on Jul. 9, 2018.

(51) Int. Cl. G02F 1/1337; G02F 1/1339; G02F 1/1335

(52) U.S. Cl. CPC G02F 1/13378; G02F 1/133512; G02F 1/1339

(57) ABSTRACT

A display device substrate includes a substrate, a common electrode, a pixel electrode, and an interlayer insulating film. The common electrode is disposed on an upper layer side of the substrate. The pixel electrode is disposed on a layer different from the common electrode to from an electric field between the pixel electrode and the common electrode. The interlayer insulating film is disposed between layers of the pixel electrode and the common electrode. The insulating alignment film covering the pixel electrode, interlayer insulating film, and the common electrode. The pixel electrode includes a contact part in contact with the alignment film.

### CROSS REFERENCE TO RELATED APPLICATION

This application claims priority from U.S. Provisional Patent Application No. 62/695,348 filed on Jul. 9, 2018. The entire contents of the priority application are incorporated herein by reference.

### TECHNICAL FIELD

The technology described herein relates to a substrate for a display device, a display device, and a method of producing the substrate for the display device.

### BACKGROUND ART

As a liquid-crystal display device for switching liquid-crystal molecules to a plate surface direction (horizontal direction) of a substrate, one operating in FFS (Fringe Field Switching) mode has been known. In the liquid-crystal display device in FFS mode, a pixel electrode and a common electrode are both formed on one of two glass substrate which interposes a liquid crystal, and these are disposed on different layers via an interlayer insulating film. By generating an oblique electric field. (so-called fringe electric field) by these pixel electrode and common electrode, the orientation of the liquid-crystal molecules is controlled.

As one example of the liquid-crystal display device in FFS mode, one described in Japanese Unexamined Patent Application Publication No. 2010-230774 has been known. In a liquid-crystal display device substrate described in the publication, a pixel electrode has a slit as a narrowly-elongated opening and a strip part (transparent conductive layer) separated by the slit, and an interlayer insulating film (passivation layer) a lower layer of the pixel electrode is formed so that a thickness under the slit and a thickness under the strip part are different from each other. Specifically, the interlayer insulating film is formed so as to have a thickness under the slit is thinner compared with a thickness under the strip part. Liquid crystal enters this thinned portion to allow enhancement of electric field intensity applied to a liquid-crystal layer. As a result, low driving voltage and low power consumption of the liquid crystal can be achieved.

However, according to the method, since the thickness of an interlayer insulating film under the slit is made thinner by etching, unevenness tends to occur in the film thickness. Unevenness of the film thickness invites fluctuations in voltage to be applied to the liquid-crystal layer. Also, in the liquid-crystal display device substrate, electric charge structurally tends to be accumulated on an interface between the interlayer insulating film and as alignment film, which is insulating layer disposed thereon. The amount of accumulation of electric charge on this interface increase with time of application of driving voltage of the liquid crystal, leading to fluctuations in applied voltage of the liquid-crystal layer. When the applied voltage of the liquid-crystal layer fluctuates, this may cause luminance flicker and so forth in the display device. Furthermore, this accumulated electric charge slightly forms voltage even when the driving voltage of the liquid crystal is turned OFF, thereby causing an afterimage (so-called burn-in) to occur in the display device.

### SUMMARY

The technology described herein has been completed based on the above-described circumstances, and has an object of inhibiting fluctuations of the voltage to be applied to the liquid-crystal layer for stabilization and inhibiting an afterimage.

A display device substrate includes a substrate, a common electrode disposed on an upper layer side of the substrate, a pixel electrode disposed on a layer different from the common electrode to from an electric field between the pixel electrode and the common electrode, an interlayer insulating film disposed between layers of the pixel electrode and the common electrode, and an insulating alignment film which covers the pixel electrode, the interlayer insulating film, and the common electrode, wherein the pixel electrode has a contact part in contact with the alignment film.

A method of producing a display device substrate includes a first film formation step of forming an insulating film to provide an interlayer insulation film on a common electrode formed in a solid pattern on an upper layer side of a substrate, a second film formation step of forming an electrode film to provide a pixel electrode on the insulating film, a resist film formation step of forming a resist film on the electrode film after the second film formation step, an exposure step of selectively exposing a part of the resist film via a photomask including a pattern in accordance with a thin-film pattern of the pixel electrode after the resist film formation step, a development step of developing the resist film after the exposure step to form a resist pattern in accordance with the thin-film pattern of pixel electrode, a first etching step of etching the electrode film using the resist pattern as a mask after the development step to selectively remove a part of the electrode film to form a pattern of the pixel electrode, a second etching step of etching the insulating film using the resist pattern as a mask after he first etching step to selectively remove a part of the insulating film to form a pattern of the interlayer insulating film, and a peeling step of peeling the resist pattern.

According to the technology described fluctuations of the voltage to be applied to the liquid-crystal layer can be inhibited for stabilization, and an afterimage can be inhibited.

### BRIEF DESCRIPTION OF THE DRAWINGS

FIG. 1 is a plan view depicting a connection structure of a liquid-crystal panel and a flexible substrate according to a first embodiment.

FIG. 2 is a sectional view depicting a sectional structure of the entire liquid crystal panel.

FIG. 3 is a plan view depicting a line structure in a display area of an array substrate configuring the liquid-crystal panel.

FIG. 4 is a sectional view of FIG. 3 along a IV-IV line.

FIG. 5 is a sectional view of FIG. 2 along a V-V line.

FIG. 6 is a flow diagram for describing an array substrate manufacturing step.

FIG. 7 is a flow diagram for describing another array substrate manufacturing step.

FIG. 8A is a diagram depicting a first process by a first etching step and a second etching step.

FIG. 8B is a diagram depicting a second process by the first etching step and the second etching step.

FIG. 8C is a diagram depicting a third process by the first etching step and the second etching step.

FIG. 9 is a sectional view of an array substrate according to a first comparison example.

FIG. 10 is a graph depicting results of a first comparison experiment.

### DETAILED DESCRIPTION

### First Embodiment

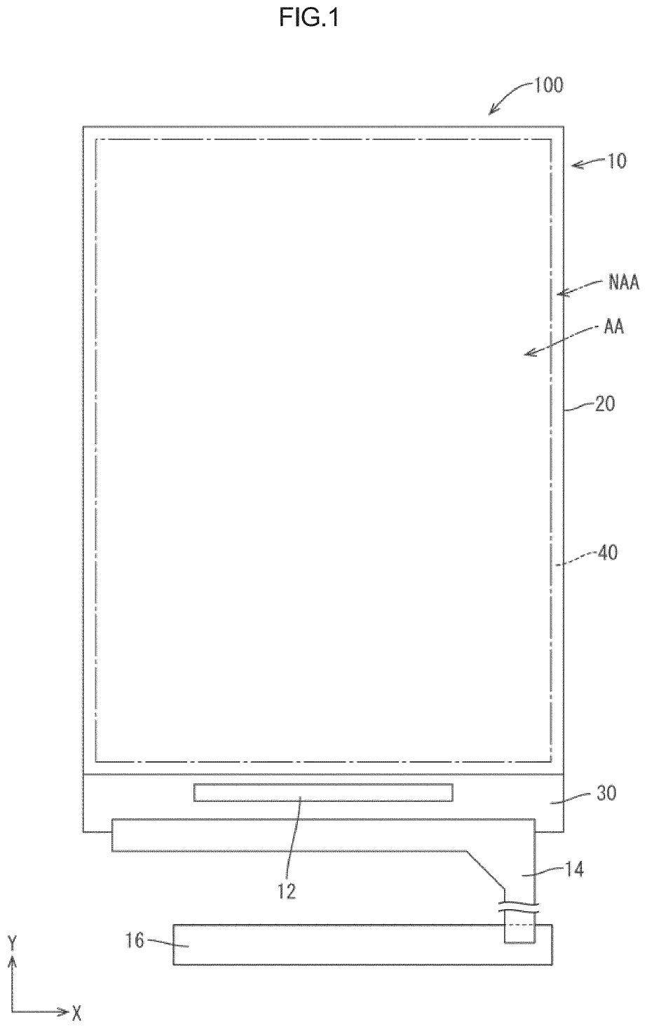

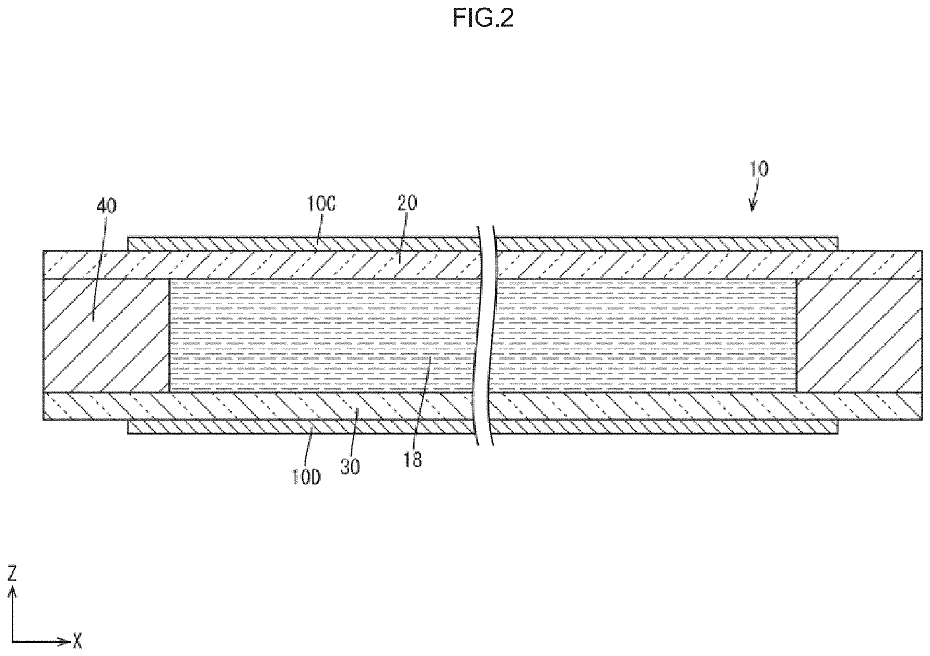

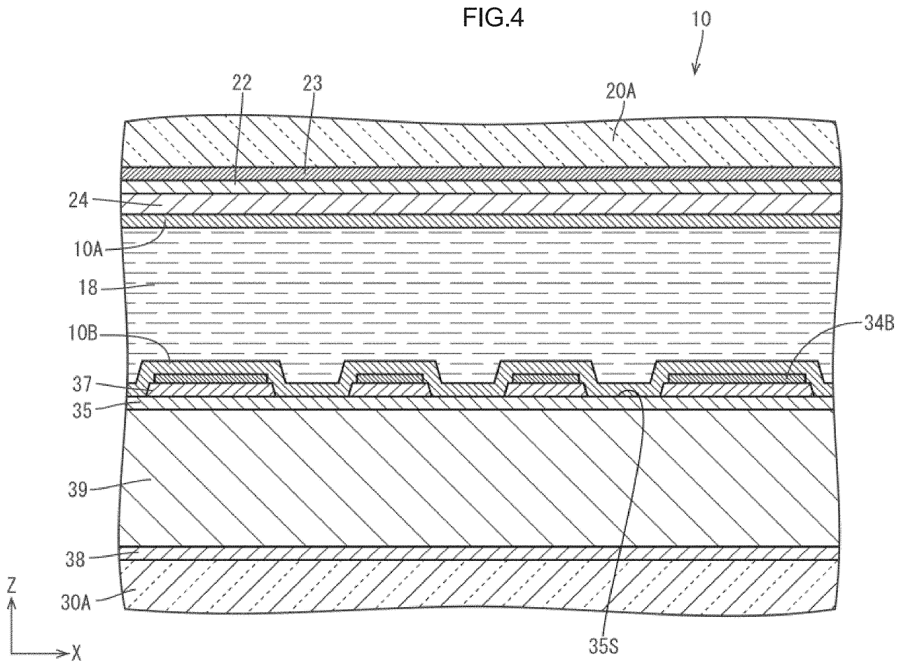

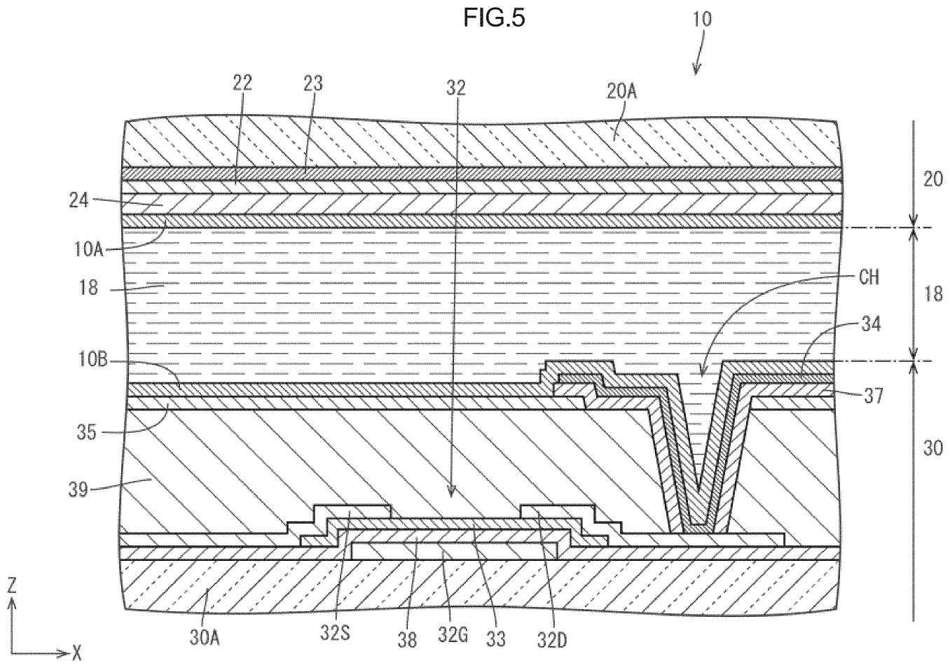

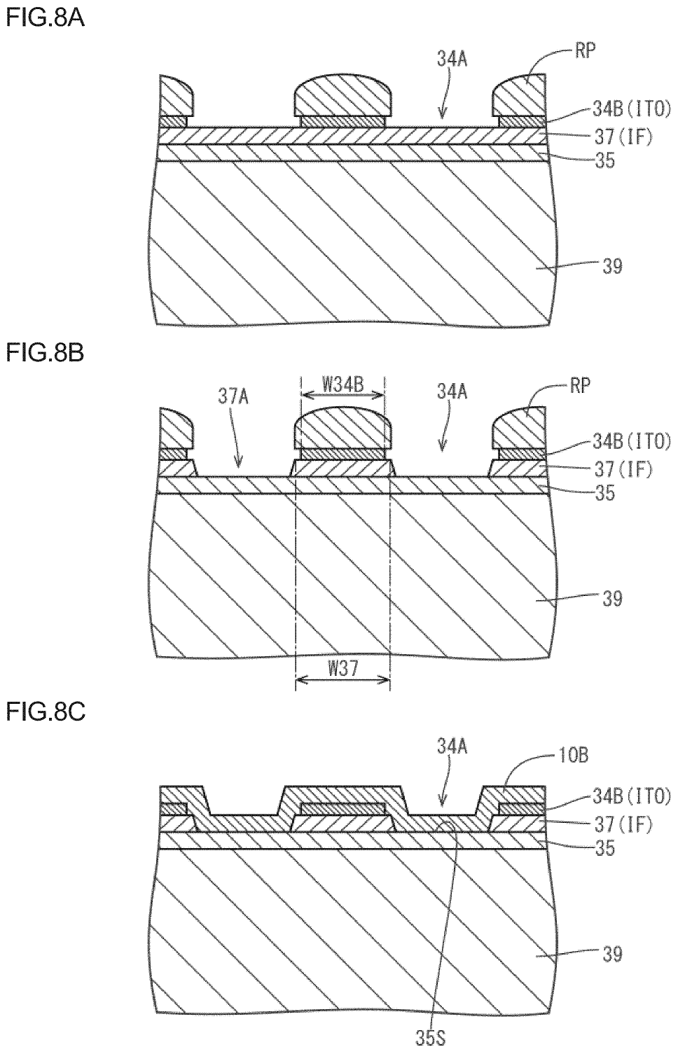

A first embodiment is described based on FIG. 1 to FIG. 5. In the present embodiment, liquid-crystal panel (display panel) 10 included in a liquid-crystal display device (display device) 100 is exemplarily described. Note that an X axis, a Y axis, and a Z axis are depicted in a part of each drawing and rendered so that each axial direction indicates the same direction in each drawing. Also, in the following, in FIG. 2, FIG. 4, FIG. 5, FIG. 8A, FIG. 8B, and FIG. 8C, an upper side in the drawing is a front side of the liquid-crystal panel 10 and a lower side is a back side.

The liquid-crystal device 100 includes, as depicted in a plan view of FIG. 1, at least a liquid-crystal panel 10 capable of displaying images, driver (panel driving part, driving circuit part) 12 which drives the liquid-crystal panel 10, a control circuit board (external signal supply source) 16 which externally supplies various input signals to the driver 12, a flexible substrate (external connection component) 14 which electrically connecting the liquid-crystal panel 10 and an external control circuit board 13 together, and a backlight device (not depicted), which is an external light source disposed on a back side with respect to the liquid-crystal panel 10 to apply light for display to the liquid-crystal panel 10.

As depicted in FIG. 1, the liquid-crystal panel 10 forms a longitudinally-elongated quadrate shape (rectangular shape) as a whole, with its inner surface partitioned into a display area (active area) AA disposed on a center side and capable of displaying images and a non-display area (non-active area) NAA disposed on an outer peripheral side surrounding the display area AA to form a frame shape (picture frame shape) in a planar view. The short-side direction in this liquid-crystal panel 10 matches the X-axis direction in each drawing, the long-side direction matches the Y-axis direction in each drawing and, furthermore, the plate thickness direction matches the Z-axis direction. Note in FIG. 1 that a one-dot-chain line indicates the outer shape of the display area AA and an area outside the one-dot-chain line is the non-display area NAA.

The liquid-crystal panel 10 includes, as depicted in a sectional view of FIG. 2, at least two substrates 20 and 30, a liquid-crystal layer (inner space) 18 interposed between of the substrates 20 and 30 and including liquid-crystal molecules, which are substances with optical characteristics changing with the application of an electric field, and a sealing part 40 interposed between both of the substrates 20 and 30 so as to surround the liquid-crystal layer 18 to seal the liquid-crystal layer 18 as keeping a cell gap for the thickness of the liquid-crystal layer 18. Of the substrates 20 and 30, a front side (frontal side) is taken as a CF substrate (common substrate, color filter substrate) 20, and a back side (rear side) is taken as an array substrate (display device substrate, active matrix substrate, TFT substrate) 30. The CF substrate 20 and the array substrate 30 are formed with various films stacked on an inner surface side of the glass-made glass substrates (substrates) 20A and 30A, respectively. The sealing part 40 is disposed in the non-display area NAA of the liquid-crystal panel 10, and forms a longitudinally-elongated, substantially frame shape along the non-display area NAA in an upper view (viewed from the direction of the normal to the plate surfaces of both of the substrates 20 and 30). Note that polarizing plates 10C and 10D are respectively laminated on the outer surface sides of both of the substrates 20 and 30.

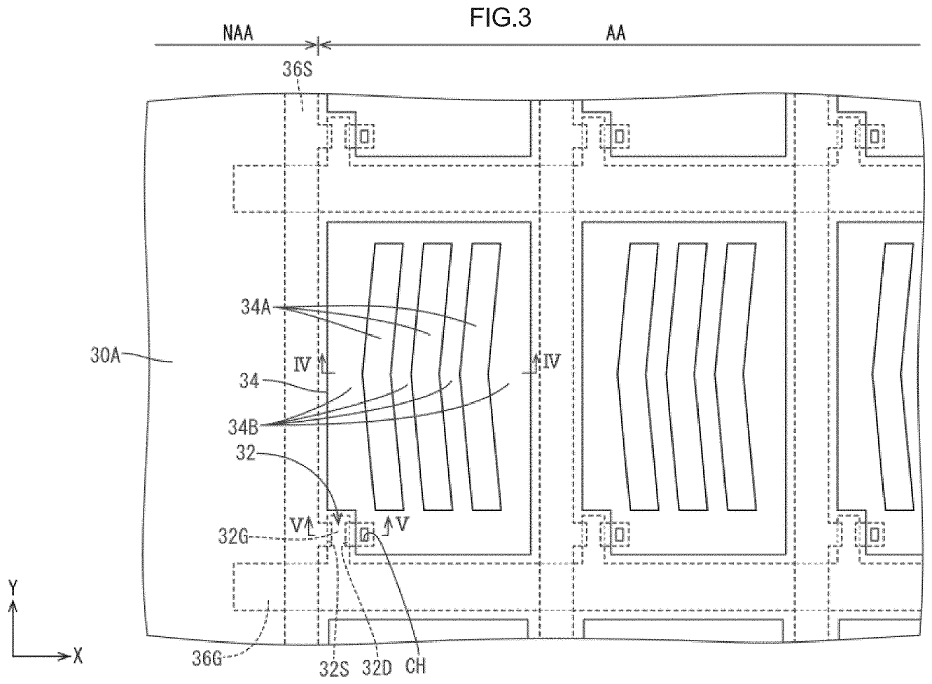

On an inner surface side (liquid-crystal layer 18 side, side of an opposing surface to the CF substrate 20) of the array substrate 30 in the display area AA, as depicted in FIG. 3, many TFT (Thin Film Transistors) as switching elements and pixel electrodes 34 are provided so as to be aligned in a matrix (matrix). Also, gate lines (scanning lines) 36G and source lines (data lines, signal lines) 36S forming a lattice are disposed on the periphery of these TFT 32 and pixel electrodes 34 so as to surround them. The gate lines 36G each branch so as to extend from the proximity of a portion crossing the source line 36S in parallel with the source line 36S. The source lines 36S also each branch so as to extend from, the proximity of a portion crossing the gate line 36G in parallel with the gate line 36G. And, a tip part to which the gate line 36G branches to extend and a tip part to which source line 36S branches to extend are superposed each other in a planar view, and a portion of that superposition includes the TFT 32 provided thereto. The tip part to which the gate line 36G branches includes a gate electrode 32G of the TFT 32 formed thereon, and the tip part to which the source line 36S branches includes a source electrode 32S of the TFT 32 formed thereon.

The gate lines 36G and the gate electrode 32G are each formed of a metal laminated film having metal films made of tungsten (W), molybdenum (Mo), or the like stacked. The source lines 36S the source electrodes 32S, and drain electrodes 32D are configured of the same material, and formed of a metal laminated film having a layer made of molybdenum (Mo), a layer made of aluminum (Al), and a layer made of molybdenum (Mo) sequentially stacked.

Alternatively, the gate lines 36G and the gate electrodes 32G are each formed of a metal laminated film having metal films made of titanium (Ti), aluminum or titanium nitride (TiN) stacked. The source lines 36S, he source electrodes 32S, and the drain electrodes 32D are configured of the same material, and each may be a metal laminated film having a layer made of titanium (Ti) and a layer made of a layer made of aluminum (Al) sequentially stacked.

The pixel electrode 34 includes at least one or more (three in the present embodiment) slits 34A, which are slightly-bent, narrowly-elongated openings. With this, the planar shape of the pixel electrode 34 is in a ladder shape with a plurality of (four in the present embodiment) rip parts 34B separated by the slits 34A being formed in parallel.

On a lower layer side of the pixel electrode 34, as depicted in FIG. 4 (a sectional view of FIG. 3 along a IV-IV line), a common electrode 35 made of a solid pattern is formed so as to be superposed on the pixel electrode 34. The pixel electrode 34 and the common electrode 35 are each made of a transparent conductive material such as ITO (Indium Tin Oxide). Between layers of the strip parts 34B of the pixel electrode 34 and the common electrode 35, an interlayer insulating film 37 is disposed. The interlayer insulating film 37 is made of an inorganic insulating material such as silicon nitride (SiNₓ) and silicon oxide (SiO₂), and its film thickness is assumed to be on the order of 0.15 μm to 0.5 μm. On an upper layer of these, an alignment film 10B made of an organic insulating material (for example, polyimide resin) is formed so as to cover the stacked common electrode 35, interlayer insulating film 37, and pixel electrode 34. The alignment film 10B is disposed on the most inner side of the substrate 30 (near the liquid-crystal layer 18), and serves a function of orienting the liquid-crystal molecules included in the liquid-crystal layer 18 as being in contact with the liquid-crystal layer 18. The alignment film 10B is formed in a solid pattern over the non-display area NAA, in addition to the display area AA in both of the substrates 20 and 30. Under the slits 34A of the pixel electrode 34, an area where the interlayer insulating film 37 is not disposed is present, and the alignment film 10B is formed also in this area. With this, under the slits 34A, the alignment film 10B and the common electrode 35 make contact with each other, generating a contact part 35S, which is a portion of the upper surface of the common electrode 35 in contact with the alignment film 10B.

To the common electrode 35, a reference potential is applied. By controlling a potential to be applied to the pixel electrode 34 by the TFT 32, a predetermined voltage is applied between the pixel electrode 34 and the common electrode 35 to generate an electric field. With the electric field generated between the strip parts 34B of the pixel electrode 34 and the common electrode 35, a fringe electric field (oblique electric field) including, in addition to components along the plate surface of the array substrate 30, components in the direction of the normal with respect to the plate surface of the array substrate 30 is formed in the liquid-crystal layer 18, thereby allowing an alignment state of the liquid-crystal molecules included in the liquid-crystal layer 18 to switch. That is, the liquid-crystal panel 10 according to the present embodiment is in operation mode being FFS (Fringe Field Switching) mode. The liquid-crystal panel in FFS mode has a high aperture ratio and can ensure a sufficient transmitted light volume, and can also achieve high viewing-angle performance.

Note that while the interlayer insulating film 37 has a sectional shape forming trapezoid and the alignment film 10B covering the interlayer insulating film 37 is formed on an upper layer so as to have a shape along this in FIG. 4, this is by a production method described below and the sectional shape of the interlayer insulating film 37 may be a quadrature or the like. Also, while the upper surface of the interlayer insulating film 37 extends from both edge parts of the strip parts 34B in a width direction for the same length (every approximately 0.1 μm to 0.5 μm per one edge part), this is also by the production method described below, and extension is not necessarily required.

On a lower layer side of the common electrode 35, various insulating films of a gate insulating film 38 and a planarizing film 39 are formed as stacked sequentially from a glass substrate 30A side. The gate insulating film 38 and the planarizing film 39 are formed to have a uniform film thickness over a substantially entire area on the glass substrate 30A. The gate insulating film 38 is made of a transparent inorganic insulating material such as, for example, a silicon oxide film (SiOₓ) to insulate between the gate electrode 32G and a semiconductor film 33, which will be described further below. The planarizing film 39 is made of a transparent organic insulating material such as, for example, acrylic resin (such as PMMA) or polyimide resin, and has a film thickness larger than that of the other insulating films (the gate insulating film 38 and the interlayer insulating film 37), for example, on the order of 1.6 μm to 2.0 μm. With this planarizing film 39, the surface of the array substrate 30 is planarized.

Next, the TFT 32 is described in detail. The TFT 32 is arranged, as depicted in FIG. 5 (a sectional view of FIG. 3 along a V-V line), so as to be stacked from the gate electrode 32G formed on the glass substrate 30A to an upper layer side. In the TFT 32, on an upper layer side of the gate electrode 32G, the semiconductor film 33 is formed so as to bridge between the source electrode 32S and the drain electrode 32D. The source electrode 32S and the drain electrode 32D are electrically connected indirectly via the semiconductor film 33 on their lower layer side. A bridge portion between both of the electrodes 32S and 32D in this semiconductor film 33 functions as a channel area where a drain current flows. For the semiconductor film 33, an oxide semiconductor such as IGZO (Indium Gallium Zinc Oxide) can be used.

On a drain electrode 32D side of the TFT 32, a contact hole CH is formed so as to vertically penetrate through the planarizing film 39, and the drain electrode 32D is exposed inside the opening of the contact hole CH. The pixel electrode 34 is formed on a part of an upper layer side of the interlayer insulating film 37 so as to be across this contact hole CH. Through the contact hole CH, the pixel electrode 34 is connected to the drain electrode 32D.

On the other hand, on an inner surface side of the CF substrate 20 in the display area AA, depicted in FIG. 5, many color filters 22 are provided as being aligned in a matrix at positions opposing to the pixel electrodes 34 on the array substrate 30 side. The color filters 22 are formed with colored films of three colors of R (red), G (green), and B (blue) being disposed to be repeatedly aligned in a predetermined order. Between the respective color filters 22, a lattice-shaped light-shielding film (black matrix) 23 to prevent color mixture is formed. A light-shielding film 23 is arranged to be superposed on the above-described gate line 36G and source line 36S in a planar view. On the surface of the color filters 22 and the light-shielding film 23, an overcoat film 24 is provided. Also, on the surface of the overcoat film 24, a photo spacer not depicted is provided. Note that in the liquid-crystal panel 10, a set of colored films of three colors of R, G, and B in the color filters 22 and three pixel electrodes 34 opposing thereto configure one display pixel as a display unit. The display pixel is formed of a red pixel having the R color filter 22, a green pixel having the G color filter 22, and a blue pixel having the B color filter 22. These display pixels of the respective colors are disposed to be repeatedly aligned along a row direction (X-axis direction) on the plate surface of the liquid-crystal panel 10 to configure a display pixel group and many display pixel groups are disposed to be aligned along a column direction (Y-axis direction). Also, on a layer on the most inner side of the CF substrate 20 in contact with the liquid-crystal layer 18, an alignment film 10A similar to the alignment film 10B of the array substrate 30 is formed.

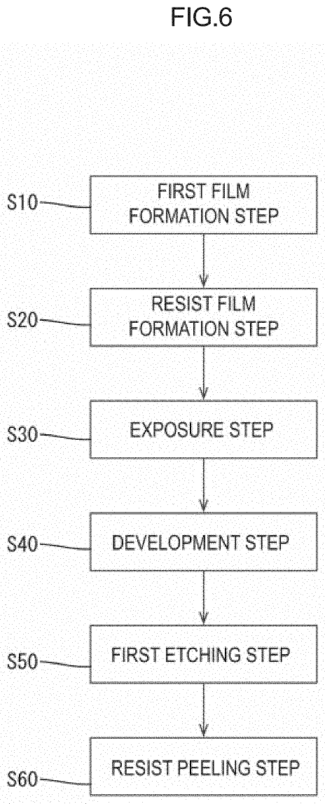

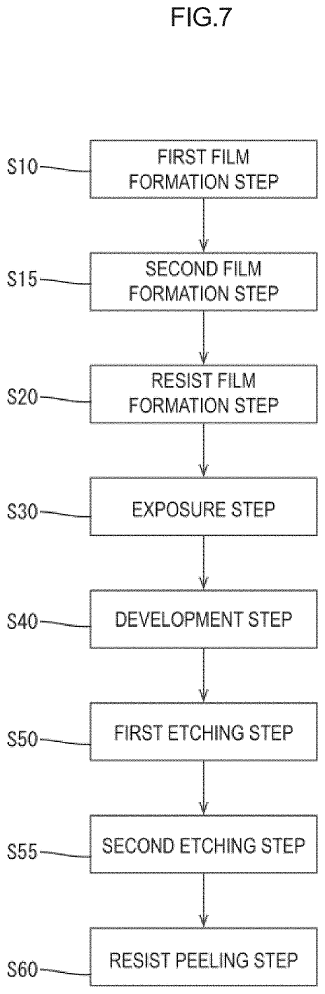

The above is the structure of the liquid-crystal panel 10 according to the present embodiment. Next, a method of producing the above-structured liquid-crystal panel 10 is described. In the method of producing the array substrate 30, thin-film patterns of various thin films are sequentially formed on the glass substrate 30A in a laminated form depicted in FIG. 5. The thin-film patterns of various thin films are formed by respective manufacturing steps depicted in FIG. 6 or FIG. 7, and these are repeatedly performed to stack the plurality of thin-film patterns on glass substrate 30A.

In the step of manufacturing the array substrate of the present embodiment, first by following a manufacturing step depicted in FIG. 6, a metal laminated film (one example of the thin film) configuring the gate line 36G and the gate electrode 32G is formed over the entire glass substrate 30A (first film formation step S10). Next, positive-type resist film is applied to the entire area on the formed metal laminated film, and the resist film is formed on the metal laminated film (resist film formation step S20).

Next, a photomask having a pattern is prepared in which a portion corresponding to the pattern of the gate line 36G and the gate electrode 32G to be formed is light-shielded, and a part of the resist film is selectively exposed via that photomask (exposure step S30). As a result, a pattern of the photomask is transferred to the resist film formed on the metal laminated film. That is, of the resist film, a portion except the portion corresponding to the pattern of the gate line 36G and the gate electrode 32G to be formed is exposed.

Next, the glass substrate 30A is immersed in a TMAH (Tetra Methyl Ammonium Hydroxide) aqueous solution or the like to develop the resist film (development step S40). As a result, a portion of the resist film with light applied at the exposure step S30 is removed, and a portion without light applied is left to form a resist pattern.

Next, using the resist pattern formed on the metal laminated film as a mask, the metal laminated film is etched to remove a part of the metal laminated film (first etching step S50). Note that any method of etching the metal laminated film can be used without restriction. With this, a portion of the metal laminated film not superposed on the resist pattern is removed, and a thin-film pattern of the same pattern shape of the resist pattern is formed. Next, the resist pattern is peeled from the thin-film pattern (resist peeling step S60). Specifically, the resist pattern is peeled by using a peeling solution such as an organic solvent. With this, the thin-film pattern is exposed onto the glass substrate 30A. With the above-described steps, the thin-film pattern of the gate line 36G and the gate electrode 32G is formed on the glass substrate 30A.

Next, for an inorganic material configuring the gate insulating film 38, the respective steps from the above-described first film formation step S10 to the above-described resist peeling step S60 are sequentially performed to form the thin-film pattern of the gate insulating film 38 on the thin-film pattern of the gate line 36G and the gate electrode 32G. Then, for each of various thin films to be formed on an upper layer side of the gate insulating film 38, that is, an oxide semiconductor configuring the semiconductor film 33; a metal laminated film configuring the source line 36S, the source electrode 32S, and the drain electrode 32D; an acrylic resin film configuring the planarizing film 39; and a transparent electrode film configuring the common electrode 35, the respective steps from the above-described first film formation step to the above-described resist peeling step are performed sequentially from a lower layer side.

Then, after formation of the thin-film pattern of the common electrode 35, the interlayer insulating film 37 and the pixel electrode 34 form a thin-film pattern by following each manufacturing step depicted in FIG. 7. Specifically, first at the first film formation step S10, an inorganic insulating film IF configuring the interlayer insulating film 37 is formed and, on this inorganic insulating film IF, a transparent electrode film ITO configuring the pixel electrode 34 is formed (second film formation step S15). Then, on the transparent electrode film ITO, a resist pattern RP is formed by the above-described resist film formation step S20, exposure step S30, and development step S40. Next, using the resist pattern RP as a mask, the transparent electrode film ITO is etched (first etching step S50, refer to FIG. 8A). This etching is preferably wet etching with a liquid as a corrosive and, for example, oxalic acid can be used as a corrosive. Note that at the time of wet etching, since the corrosive goes round to enter a lower surface of the resist pattern RP, the outer periphery of the thin-film pattern of the transparent electrode film ITO is slightly eroded to the inside from the outer periphery of the resist pattern RP. With this a width W34 of the strip part 34B of the pixel electrode 34 is slightly smaller than the width of the resist pattern RP.

Next, at a second etching step S55, using the resist pattern RP on the thin-film pattern of the transparent electrode film ITO as a mask, the inorganic insulating film IF configuring the interlayer insulating film 37 is etched (refer to FIG. 8B). For corrosive at the second etching step, one not reacting with the transparent electrode film ITO and capable of selectively removing the inorganic insulating film IF is used. For this etching, dry etching with an air as a corrosive is preferable. For a corrosive, for example, mixed gas of carbon tetrafluoride (CF₄) and oxygen (O₂) can be used. Note that at the time of dry etching, since the lower side of the inorganic insulating film IF is difficult to be etched because the corrosive is difficult to reach there, the interlayer insulating film has a trapezoidal sectional shape. Also, in the case of dry etching, since the corrosive is difficult to go round to enter the lower surface of the resist pattern RP, a width W37 of the upper surface of the interlayer insulating film 37 substantially matches the width of the resist pattern RP. Thus, compared with the width W34 of the strip part 34B of the pixel electrode 34 described above, the width W37 of the upper surface of the interlayer insulating film 37 slightly larger.

Since the first etching step S50 and the second etching step S55 use the same resist pattern RP as a mask, the pixel electrode 34 and the interlayer insulating film 37 have a substantially same shape. Also, under the slit 34A of the pixel electrode 34, an area 37A with the interlayer insulating film 37 removed is provided. After formation of the thin-film pattern of the inorganic insulating film IF configuring the interlayer insulating film 37, with the resist peeling step S60, the resist pattern is peeled from the thin-film pattern of the transparent electrode film ITO configuring the pixel electrode 34.

With the above-described procedure, all thin-film patterns configuring the array substrate 30 are formed on the glass substrate 30A. When polyimide resin configuring the alignment film 10B is applied to that surface, the array substrate 30 is completed (refer to FIG. 8C). Here, the alignment film 10B enters the area 37A from which the interlayer insulating film 37 is removed to cover the common electrode 35, thereby generating the contact part 35S in contact with the alignment film 10B on an upper surface of the common electrode 35. The planar shape of the contact part 35S is along the shape of the slit 34A of the pixel electrode 34.

Here, a method of producing the CF substrate 20 is briefly described. In a step of manufacturing the CF substrate 20, the light-shielding film 23 is first formed on the glass substrate 20A, which is processed into a substantially lattice shape by a photolithography scheme. The light-shielding film 23 is formed of, for example, a resin containing carbon. Next, the respective colored parts configuring the color filter 22 are formed at desired positions. Next, a transparent insulating film as a protective film is formed to cover the light-shielding film 23 and the color filter 22. This insulating film is formed using any of silicon dioxide (SiO₂), silicon nitride (SiN₂), a heat-reactive epoxy resin, and an ultraviolet-curing acrylic resin that can be subjected to patterning. Then, the alignment film 10A is formed on the surface of the insulating film.

The glass substrate 30A having the array substrate 30 formed thereon and the glass substrate 20A having the CF substrate 20 formed thereon are each completed. When the sealing part 40 is applied onto the glass substrate 30A along the outer shape of the array substrate 30, both of the glass substrates 20A and 30A are laminated via the sealing part 40 to form a laminated substrate. Next, for the laminated substrate, the liquid-crystal layer 18 is injected between the array substrate 30 and the CF substrate 20, and the space between both of the substrates 20 and 30 is filled with the liquid-crystal layer 18. Then, on outer surface sides of both of the substrates 20 and 30, the polarizing plates 10C and 10D are respectively laminated, thereby completing the liquid-crystal panel 10.

Next, operations and effects are described about the structure of the liquid crystal panel 10 according to the present embodiment described above and the production method thereof. In the above-structured liquid-crystal panel 10, the alignment film 10B and the upper surface of the common electrode 35 make contact at the contact part 35S, allowing electric charge accumulated on an interface between the liquid-crystal layer 18 and the alignment film 10B to flow out from the alignment film 10B to the common electrode 35. Also, since the interlayer insulating film 37 is removed under the slit 34A of the pixel electrode 34, unlike the conventional technology, electric charge is not accumulated on an interface between the interlayer insulating film 37 and the alignment film 10B under the slit 34A. With accumulation of electric charge solve in this manner, the occurrence of an afterimage can be inhibited. Also, fluctuations in voltage to be applied to the liquid-crystal layer are inhibited to stabilize applied voltage.

### First Comparison Experiment

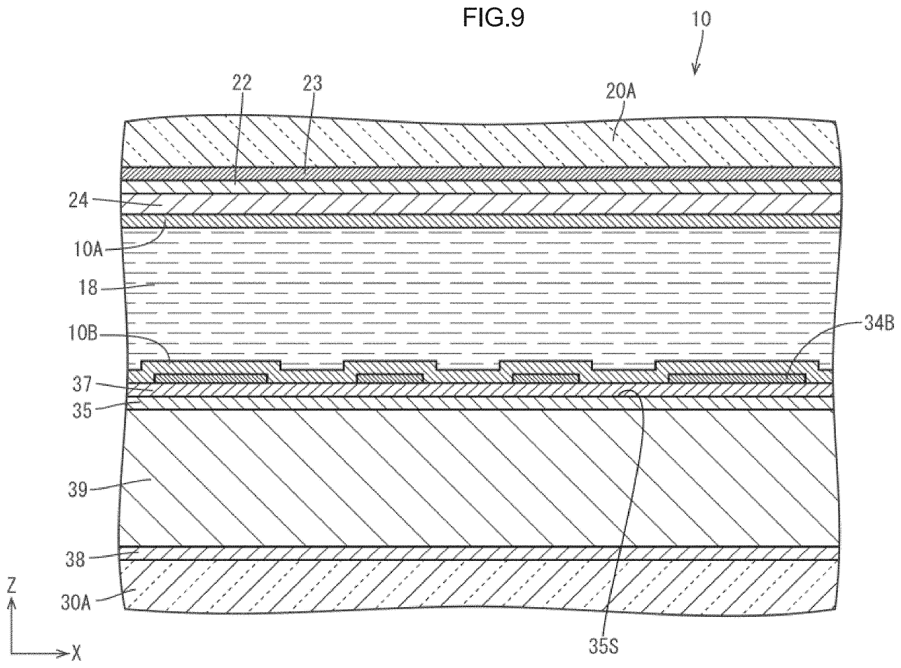

To demonstrate operations and effects as described above, a first comparison experiment was performed. In the first comparison experiment, an example in which the interlayer insulating film 37 under the slits 34A of the pixel electrodes 34 is removed and the common electrode 35 includes the contact part 35S in contact with the alignment film 10B is taken as a first example and, as depicted in FIG. 9, an example in which the interlayer insulating film 37 is formed to have a uniform film thickness and the alignment film 10B and the common electrode 35 are not in contact with each other is taken as a first comparison example. As for the first example and the first comparison example, luminance flicker was evaluated.

As the alignment film 10B, a photo horizontal alignment film made of a polymer of tetracarboxylic dianhydride having a cyclobutane skeleton and diamine was used in which, when subjected to a photo alignment process by applying polarized light, a polymer main chain substantially in parallel to its polarizing direction is selectively dissolved for sublimation reaction to exhibit alignment. In film formation, pattern printing was performed by flexography printing, and the film thickness after firing was 100 nm. Then, over a wavelength filter which cuts 240 nm or lower, ultraviolet light of 300 mJ/Cm² for wire grid polarization (extinction ratio of 50:1) was applied, and firing was performed at 230° C. for thirty minutes, thereby processing the liquid crystal for horizontal alignment.

Also, as for the alignment film 10B here, when a film volume resistivity was measured as a cell interposed in a sandwich form between a transparent electrode and an aluminum electrode having a film thickness of 200 nm and a ϕsize of 1 mm, it was 2×10¹⁵ Ωcm under a darkroom environment and 7×10¹³ Ωcm at the time of LED backlight radiation.

Luminance flicker was evaluated by applying a voltage of +2.5 V to the pixel electrode 34 to measure a flicker ratio in screen display with gray gradation and graphically show changes of the flicker ratio with time with respect to voltage application time. The flicker ratio is a value defined by a ratio of an amplitude half width of luminance flicker with respect to an average of amplitude of a luminance ratio and, for its measurement, “multimedia display meter 3298F” manufactured by Yokogawa Electric Corporation was used. As the flicker ratio is higher, fluctuations of luminance are larger and flicker is larger, and therefore display quality is lower.

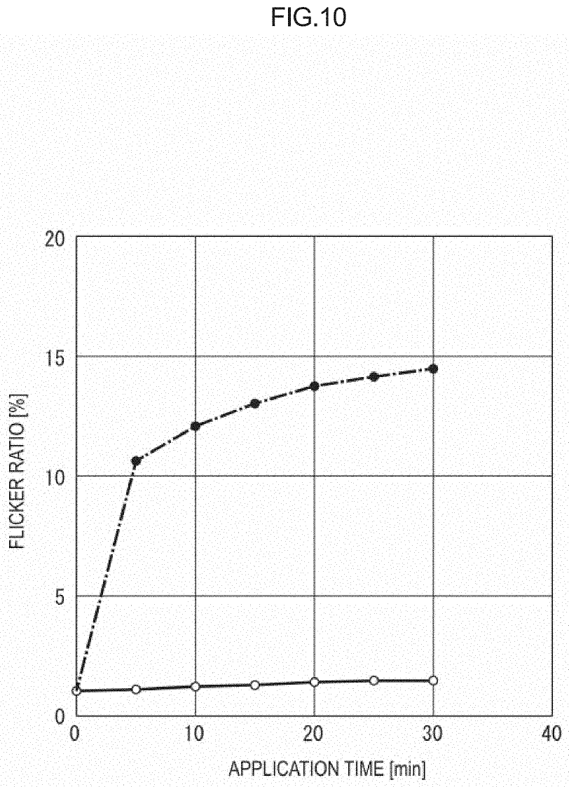

The experiment results of the first comparison experiment are described with reference to a graph of FIG. 10. In a liquid-crystal panel according to the first comparison experiment, as depicted by a graph indicated by a one-dot-chain line, when the voltage was applied for five minutes, the flicker ratio abruptly increased to 10% or more. The flicker ratio also gradually increased thereafter with voltage application time, resulting in reaching near 15% after a lapse of thirty minutes. The reason for this can be thought that when the voltage was applied, electric charge was accumulated on the interface between the liquid-crystal layer and the alignment film and the interface between the alignment film and the interlayer insulating film and the amount of accumulation of electric charge increased with a lapse of application time. On the other hand, in the liquid-crystal panel according to the first embodiment, as depicted by a graph indicated by a solid line, the flicker ratio was small after the application of voltage, less than 2.0%, and the flicker ratio was kept small after a lapse of thirty minutes. The reason for this can be thought that the alignment film and the upper surface of the common electrode made contact with each other and electric charge accumulated on the interface between the liquid-crystal layer and the alignment film was flown out to the common electrode via the contact surface. Also, with the interlayer insulating film removed under the slit of the pixel electrode, electric charge is not accumulated in the first place on the interface between the interlayer insulating film and the alignment film under the slit.

Also, the structure according to the present embodiment can be easily achieved by the above-described method. That is, a resist film used in the thin-film pattern formation (first etching step 350) of he pixel electrode 34 is used directly for the thin-film pattern formation (second etching step 355) of the interlayer insulating film 37 and, by using a different corrosive for each etching step, the interlayer insulating film 37 can be easily removed under the slit 34A of the pixel electrode 34. Then, when the alignment film 10B is applied from above these layers, the contact part 35S of the common electrode 35 in contact with the alignment film 10B can be easily formed in the area with the interlayer insulating film 37 removed.

### Other Embodiments

The technology described herein is not limited to the embodiments described based on the above description and the drawings and, for example, the following embodiments are also included in the technological scope of the technology described herein.

(1) In the above-described embodiment, the example has been described in which the pixel electrode has a ladder shape. However, the number and shape of slits can be changed as appropriate. The shape of the pixel electrode may be a stepped shape, a comb shape with one end of the opening of each slit being open, or the like.

(2) The thin-film patterns of the gate lines, the gate electrodes, the source lines, the source electrodes, the drain electrodes, and various insulating films in the above-described embodiment are merely an example, and can be changed as appropriate.

(3) In the above-described embodiment, the example has been described in which the gate lines, the gate electrode, the source lines, the source electrodes, and the drain electrodes are formed of metal laminated films. However, the metal material for use in each of the stacked layers can be changed as appropriate, and a single-layer film made of a metal material of one type may be used. Also, while the example has been described in which the semiconductor film configuring the channel part of the TFT is made of an oxide semiconductor material, another semiconductor material such as amorphous silicon can also be used.

(4) In the above-described embodiment, the example has been described in which the switching element is a TFT. However, another semiconductor element may be used. Also, depending its structure and so forth, another insulating film may be included between the planarizing film and the switching element.

(5) In the manufacturing step according to the above-described embodiment, a cleaning step of cleaning the glass substrate by using a cleaning fluid such as ultrapure water may be added after the development step. A portion of the resist film with light applied in the exposure step can be removed with high accuracy. Also, a post baking step of heating the glass substrate may be performed after the above-described cleaning step. The cleaning fluid attached onto the metal laminated film and the resist pattern in the above-described cleaning step can be removed, and adhesion between the resist pattern and the metal laminated film can be improved.

(6) In the above-described embodiment, the example has been described in which a sealant is applied to the array substrate to laminate in and the CF substrate. Both substrates may be laminated by applying a sealant to the CF substrate.

In the above-described embodiment, the photolytic alignment film having a cyclobutane skeleton is used. However, the alignment film may be an alignment film aligned by rubbing, an alignment film horizontally aligned by photoisomerization reaction with a side chain having any of a diazobenzene skeleton, cinnamate skeleton, and chalcone skeleton being subjected to polarized radiation with ultraviolet rays, or an alignment film horizontally aligned with polarized radiation with ultraviolet rays to cause Fries rearrangement. The film volume resistivity is not particularly restrictive.

(8) In each of the above-described embodiments, the liquid-display panel having a planar shape being a rectangle has been described. However, the technology described herein can be applied also to liquid-crystal panel having a planar shape being any of a square, circle, oval, and so forth.

(9) In each of the above-described embodiments, the liquid-crystal panel with its operation mode being the FFS mode has been exemplarily described. Other than that, the technology described herein can be applied also to liquid-crystal panels in other operation modes such as IPS (In-Plane Switching) mode and VA (Vertical Alignment) mode.

(10) In each of the above-described embodiments, the liquid-crystal panel configured with the liquid-crystal layer interposed between the two substrates and the production method thereof have been exemplarily described. However, the technology described herein can be applied also to a display panel with functional organic molecules (medium other than the liquid-crystal material interposed between two substrates.

(11) In each of the above-described embodiments, the liquid-crystal panel has been exemplarily described as a display panel. However, the technology described herein can be applied also to display panels of other types (such as a PDP (plasma display panel), organic EL panel, EPD (electrophoretic display panel), and MEMS (Micro Electro Mechanical Systems) display panel).

1. A display device substrate comprising:
a substrate;
a common electrode disposed on an upper layer side of the substrate;
a pixel electrode disposed on a layer different from the common electrode to from an electric field between the pixel electrode and the common electrode;
an interlayer insulating film disposed between layers of the pixel electrode and the common electrode; and
an insulating alignment film covering the pixel electrode, the interlayer insulating film, and the common electrode, wherein
the pixel electrode includes a contact part in contact with the alignment film.

2. The display device substrate according to claim 1, wherein
the pixel electrode includes a slit that is an opening in a narrowly-elongated shape and a strip part separated by the slit, and
the common electrode is formed in a solid pattern to overlap the pixel electrode.

3. The display device substrate according to claim 2, wherein an area where the interlayer insulating film is not disposed is included between the layers of the slit of the pixel electrode and the common electrode.

4. The display device substrate according to claim 2, wherein
the common electrode, the interlayer insulating film, the pixel electrode, and the alignment film are disposed in this sequence from a lower layer side, and
the contact part is disposed on a lower layer side of the slid of the pixel electrode.

5. The display device substrate according to claim 2, wherein the contact part has a planar shape along a planar shape of the slit.

6. The display device substrate according to claim 1, wherein the alignment film is made of an organic resin material.

7. The display device substrate according to claim 1, wherein
the substrate includes a thin-film transistor connected to the pixel electrode, and
a drain electrode of the thin-film transistor is connected to the pixel electrode.

8. A display device comprising:
a display device substrate according to claim 1; and
a common substrate disposed so as to be opposed in a form of having an inner space between the common substrate and the display device substrate.

9. The display device according to claim 8, further comprising a sealing part interposed between the display device substrate and the common substrate and sealing the inner space by surrounding the inner space, wherein
liquid crystal is sealed in the inner space.

10. A method of producing a display device substrate, the method comprising:
a first film formation step of forming an insulating film on a common electrode formed in a solid pattern on an upper layer side of a substrate to provide an interlayer insulation film;
a second film formation step of forming an electrode film to provide a pixel electrode on the insulating film;
a resist film formation step of forming a resist film on the electrode film after the second film formation step;
an exposure step of selectively exposing a part of the resist film via a photomask including a pattern in accordance with a thin-film pattern of the pixel electrode after the resist film formation step;
a development step of developing the resist film after the exposure step to form a resist pattern in accordance with the thin-film pattern of the pixel electrode;
a first etching step of etching the electrode film using the resist pattern as a mask after the development step to selectively remove part of the electrode film to form a pattern of the pixel electrode;
a second etching step of etching the insulating film using the resist pattern as a mask after the first etching step to selectively remove a part of the insulating film to form a pattern of the interlayer insulating film; and
a peeling step of peeling the resist pattern.

11. The method of producing the display device substrate according to claim 10, wherein a corrosive used in the first etching step is different from a corrosive used in the second etching step.

12. The method of producing the display device substrate according to claim 10, wherein
the first etching step uses wet etching with a liquid corrosive, and
the second etching step uses dry etching with a gas corrosive.
